(19) United States
(12) Patent Application Publication
(10) Pub. No.: US 2007/0137872 A1
(43) Pub. Date: Jun. 21, 2007

(54) Attachment for road grader blade for grading shoulders

(76) Inventor: Donald L. Ziebell, Minocqua, WI (US)

Correspondence Address: John W. Chestnut;Greer, Burns & Crain, Ltd., 300 South Wacker Drive, Chicago, IL, 60606, US

(21) Appl. No.: 11/311,878

(22) Filed: Dec. 19, 2005

(51) Int. Cl. A01B 13/08

(52) U.S. Cl. 172/699

(57) ABSTRACT

A blade for grading a shoulder of a road is pivotally mounted on an underbody grader blade which is advanced over the road by a vehicle. The grader blade is conventionally angled, for example, at about −30°, to a line perpendicular to the direction of travel so that material is forced by the grader blade toward the shoulder on one side of the road. The shoulder grading blade is mounted at a downward and forward angle relative to the grader blade so that the shoulder grading blade scrapes material from the shoulder onto the road and into the path of the grader blade. The grader blade then directs the material through the space between the grader blade and the shoulder blade to the shoulder and levels the material on the shoulder.

### BACKGROUND

This invention relates to the grading of gravel shoulders of roads. More particularly, the invention provides an attachment for a conventional underbody grader blade which permits gravel shoulders to be graded in a single pass of the grading equipment.

Roads are conventionally constructed of various materials including gravel, asphalt, and concrete. Most roads in urban areas have curbs or gutters to define the sides of the road and to manage rain runoff. However, many roads, particularly rural roads, have gravel shoulders. As used herein, the term “gravel” is used broadly to refer to relatively small stones and rocks, sand, earth, and similar loose material which is capable of being excavated and leveled by advancing a grader blade or similar equipment.

Gravel shoulders erode away over time from rain, water runoff, and traffic. Eroded shoulders are hazardous if low areas develop adjacent to the roadway. For example, if a vehicle tire engages a rut or low spot, the driver can lose control of the vehicle.

Gravel shoulders require periodic maintenance to grade the shoulders in order to smooth the material and to maintain the shoulder level with, or at a desired angle to, the road. Gravel shoulders are conventionally graded by a truck with an underbody grader blade. However, conventional shoulder grading technique requires either two passes by one grading vehicle or two separate vehicles operating in line. During the first pass the grader blade is oriented to grade gravel up onto the road. On the second pass the grader blade is level with the road and grades the gravel off of the road and onto the shoulder.

The invention permits gravel shoulders to be graded in a single pass by one vehicle.

Various prior art devices have been mounted on grader blades for various purposes. However, none of the prior art devices is directed to the problem which is solved by the invention.

U.S. Pat. No. 6,463,683 describes an end gate for a grader blade which is used for snow removal. The end gate is level with the grader blade and forms an extension of the grader blade.

U.S. Pat. No. 3,109,351 describes a shoulder building apparatus for road construction. A strike-off blade 54 and an edge-defining plate 56 are positioned in front of a grader blade. The blade 54 extends perpendicularly to the direction in which the vehicle is advanced.

U.S. Pat. No. 3,680,451 describes a blade which is pivotally attached to a grader blade for grading a shoulder. The shoulder blade forms a continuation of the grader blade, and there is no space between the shoulder blade and the grader blade.

U.S. Pat. No. 6,184,866 describes a blade for constructing or maintaining a shoulder. The shoulder blade extends perpendicularly to the direction in which the vehicle advances.

### SUMMARY OF THE INVENTION

The invention provides a shoulder blade attachment for a grader blade which extends downwardly and forwardly from the grader blade and at an acute angle to the direction in which the grader blade is advanced. The downward and forward angle of the shoulder blade enables the shoulder blade to excavate or retrieve gravel from the shoulder and to direct the gravel onto the road and into the path of the grader blade. The inner end of the shoulder blade is spaced from the grader blade so that the grader blade directs the gravel through the space and back onto the shoulder. Gravel is therefore removed from the shoulder and graded onto the shoulder in one pass of the vehicle.

The time needed to grade the shoulder is reduced to one-half of the time which is required by the conventional method of making two passes. The reduced time results in substantial savings to a local government, which has many miles of road to maintain.

The shoulder blade is pivotally mounted on the grader blade so that the downward angle of the grader blade can be adjusted and the grader blade can be pivoted upwardly to a transport position. A chain on the grader blade attaches to the vehicle to prevent excessive downward movement.

### DESCRIPTION OF THE DRAWING

The invention will be explained in conjunction with an illustrative embodiment shown in the accompanying drawing, in which

FIG. 1 is a schematic plan view of a conventional underbody grader blade and a shoulder blade in accordance with the invention;

FIG. 2 is a fragmentary side view of a vehicle, a grader blade, and a shoulder blade showing the grader blade and shoulder blade resting on a level road;

FIG. 3 is a fragmentary enlarged view of a portion of FIG. 2;

FIG. 4 is a fragmentary rear view showing the grader blade raised to a transport position;

FIG. 5 is an enlarged fragmentary top perspective view of the pivot attachment between the shoulder blade and the grader blade;

FIG. 6 is a fragmentary side view of the grader blade and the shoulder blade showing the grader blade on a road and the shoulder blade on an inclined shoulder;

FIG. 7 is a fragmentary top view similar to FIG. 1 showing gravel being directed by the shoulder blade and by the grader blade as the vehicle advances;

FIG. 8 is a fragmentary front sectional view taken along the line 8-8 of FIG. 7.

### DESCRIPTION OF SPECIFIC EMBODIMENT

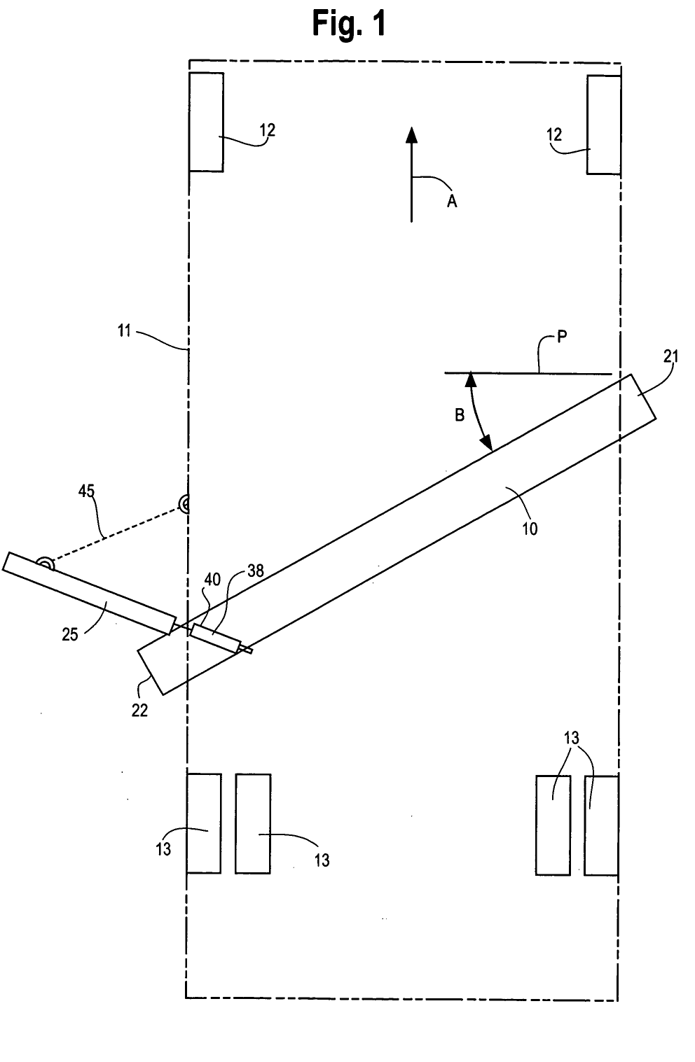

Referring to FIG. 1, a conventional underbody grader blade 10 is mounted below a vehicle 11 which is indicated in phantom outline. The vehicle can be any conventional vehicle such as a dump truck, tractor, grader or the like. The underbody grader blade is typically mounted between the front wheels 12 and rear wheels 13 of the vehicle. The vehicle is advanced in the direction of the arrow A, and the grader blade 10 is conventionally angled at a negative acute angle B with respect to a line P which is perpendicular to the direction of advance. The angle B is conventionally about −30°±10° so that gravel and other material engaged by the blade is directed to the trailing end of the blade as the vehicle and the blade advance.

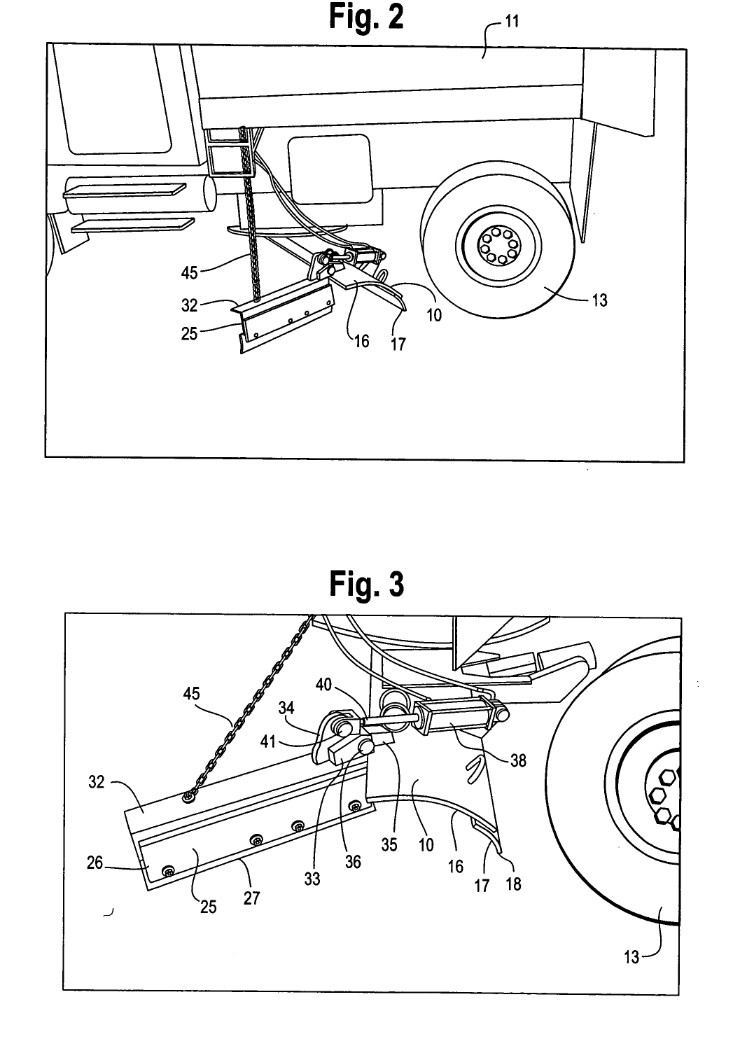

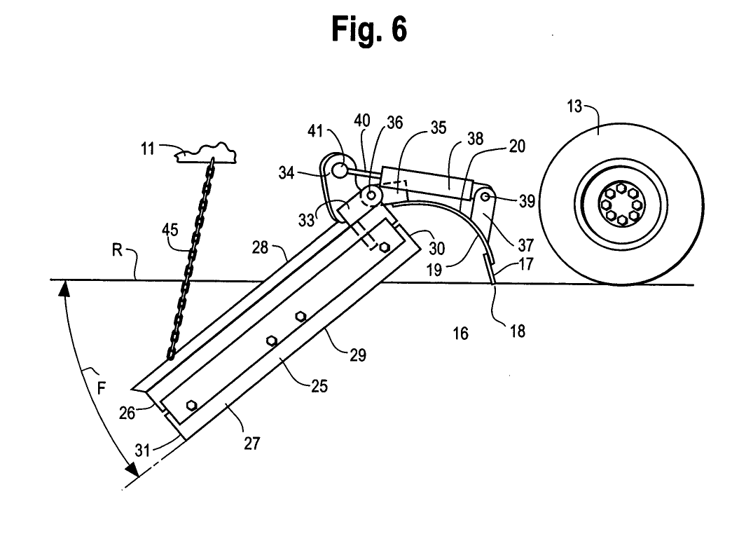

Underbody blades are well known, and the details of such a blade need not be described herein. Referring to FIGS. 2 and 3, underbody blades generally include a curved moldboard 16 and a blade 17 which is attached to the moldboard and which provides a bottom edge 18 of the grader blade. The grader blade includes front and rear surfaces 19 and 20 (FIG. 6) and right and left ends 21 and 22 (FIG. 1). An underbody blade is typically attached to a vehicle by a pivoting mounting assembly which is operated by hydraulic cylinders so that the blade can be moved between a grading position in which the bottom edge engages a road or other surface and a transport position in which the blade is raised above the surface.

A shoulder grading blade 25 is pivotally mounted on the grader blade 10 adjacent one end of the grader blade. In FIG. 1 the grader blade is oriented to direct material toward the left end of the grader blade, and the shoulder blade 25 is mounted adjacent the left end of the grader blade. Mounting the shoulder blade on the left or driver's side of the vehicle enables the driver to observe the position of the shoulder blade relative to the shoulder. However, the shoulder blade could also be mounted adjacent the right end of the grader blade, and the shoulder blade could be observed by mirrors, video, or the like.

Referring to FIG. 6, the shoulder blade 25 includes a main body 26 and a cutting blade 27 which is bolted to the main body. The shoulder blade includes top and bottom edges 28 and 29, and right and left ends 30 and 31. The top edge includes a forwardly extending shoulder or ledge 32 (FIGS. 2 and 3).

Referring to FIGS. 3-6, a clevis or bifurcated bracket or lug 33 and a lug or tongue 34 are welded to the top ledge 32 of the shoulder blade 25 adjacent the right end of the blade. A lug or tongue 35 is welded to the top of the back surface 20 of the grader blade 10. The lug 35 is pivotally retained in the clevis 33 by a pivot pin 36.

A lug 37 is welded to the lower end of the back surface 20 of the grader blade. A hydraulic cylinder 38 is pivotally attached to the lug 37 by pivot pin 39, and a piston 40 is pivotally attached to the lug 34 on the shoulder blade by pin 41. The piston is extended and retracted by pressurized hydraulic fluid which is conveyed to the cylinder by hoses 42 and 43. The hydraulic hoses can be connected to the hydraulic controls of the vehicle which operate the turning of the front snow plow blade.

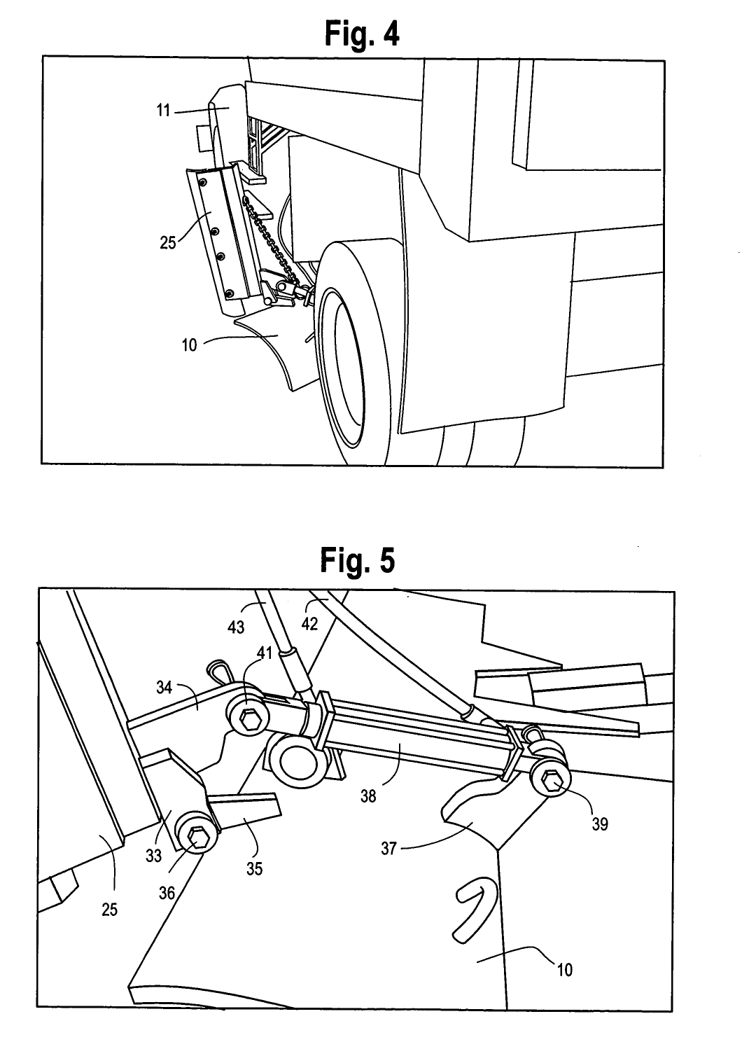

The shoulder blade 25 is pivotable by the piston 40 between a shoulder grading position illustrated in FIGS. 6 and 8 and a transport position illustrated in FIG. 4. In the shoulder grading position illustrated in FIG. 8, the bottom edge 29 of the shoulder blade extends angularly downwardly at an angle C below the bottom edge 18 of the grader blade and below the generally horizontal plane of the road R over which the grader blade moves. The angle of inclination may be controlled by the operator through the hydraulic controls for the hydraulic piston 40. The angle of inclination may be varied depending upon the angle of the shoulder relative to the road. The angle C in FIG. 8 may vary from about 10° to about 80°, preferably from about 20° to about 60°, and more preferably from about 30° to about 50°.

The angle C also defines the angle of inclination between the bottom edge of the shoulder blade and the plane which is defined by the tires 12 and 13 of the vehicle as the vehicle is supported by the road.

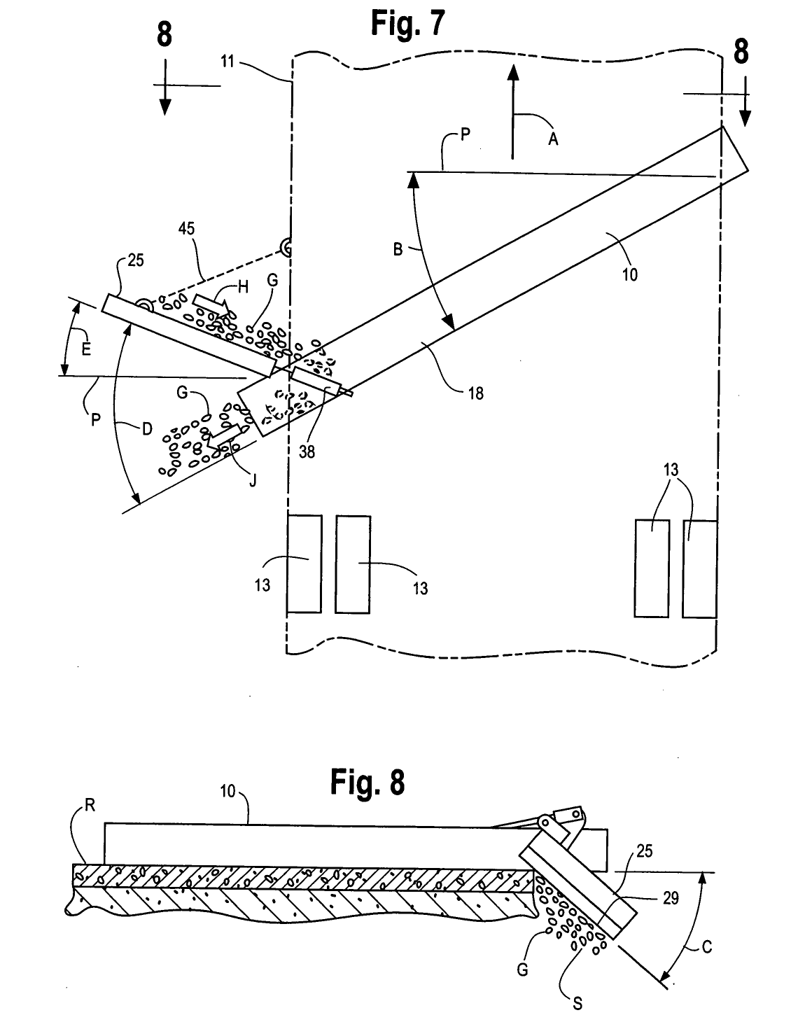

In the shoulder grading position the shoulder blade 25 is also angled forwardly relative to the grader blade 10 as illustrated in FIGS. 1 and 7. The angle D between the shoulder blade and the bottom edge 18 of the grader blade is fixed by the position of the clevis 33 and the lugs 34, 35, and 37. However, the angle is selected so that the angle E between the bottom edge of the shoulder blade and a line P which extends perpendicularly to the path A of the vehicle is between about 10° and about 50°, and preferably between about 20° and about 40°.

The angle B between the bottom edge of the grader blade and a perpendicular line P generally varies between about 20° and about 40°. The angle D between the bottom edge of the shoulder blade and the bottom edge of the grader blade would then be between about 30° and about 90°, and preferably between about 40° and about 80°.

Referring to FIG. 6, the angle F between the bottom edge 29 of the shoulder blade and the bottom edge 18 of the grader blade and the plane of the road R as viewed from the side of the vehicle depends on the angles C and E. The angle F may vary between about 0° and about −10°.

In the transport position illustrated in FIG. 4, the shoulder blade is raised out of contact with the shoulder and preferably extends substantially vertically relative to the road and to the bottom edge of the grader blade.

A chain 45 is attached to the outer end of the shoulder blade and to the body of the vehicle 11. The chain restrains or limits the outward movement of the shoulder blade beyond a desired maximum angle. The length of the chain can be varied as desired. Other types of restraining members may also be used such as a cable, wire, rope, etc. The restraining member should be flexible so that it does not interfere with movement of the shoulder blade to the transport position.

Referring the FIG. 6, when the shoulder blade 25 is in the shoulder grading position, the inner end of the bottom edge 29 of the shoulder blade is spaced forwardly from the bottom edge 18 and the front surface 19 of the grader blade. The space between the blades allows material which is graded by the grader blade to move laterally outwardly behind the shoulder blade.

The operation of the shoulder blade 25 and the grader blade 10 will be explained with reference to FIGS. 7 and 8. The downward angle C of the shoulder blade is adjusted by the operator depending upon the incline of the shoulder S relative to the road R and how much gravel material from the shoulder the operator wants to retrieve from the shoulder and place on the road. The outer end of the shoulder blade preferably extends laterally outwardly beyond the outer end of the grader blade. As the vehicle advances over the road, the shoulder blade 25 scrapes gravel material G from the shoulder, and the shoulder blade guides the material upwardly and laterally inwardly in the direction of the arrow H in FIG. 7 onto the road. High spots and low spots such as ruts in the shoulder are thereby leveled out. The material G which is forced onto the road by the shoulder blade is then guided laterally outwardly in the direction of the arrow J to the shoulder by the bottom edge 18 and the front surface 19 of the grader blade. The outer end of the grader blade preferably extends laterally outwardly beyond the edge of the road and grades the roadside edge of the shoulder level with the road. The remainder of the gravel which is graded by the grader blade may form a downwardly sloping refurbished shoulder.

The vehicle is advantageously driven at about 5 to 8 miles per hour when the shoulder is being graded. The shoulder can be refurbished during a single pass of the vehicle.

When the shoulder grading operation is completed, or when the shoulder blade encounters an obstacle, the shoulder blade is raised to the transport position by the hydraulic cylinder and piston.

While in the foregoing specification a detailed description of a specific embodiment of the invention was set forth, it will be understood that many of the details herein given may be varied considerably by those skilled in the art without departing from the spirit and scope of the invention.

I claim:

1. An apparatus for grading a shoulder of a road comprising:
an underbody grader blade adapted to be attached under a vehicle, the grader blade having a body with front and rear surfaces, a pair of ends, and a bottom edge adapted to engage a road,
a shoulder blade pivotally attached to the grader blade adjacent one end thereof and movable between a shoulder grading position and a transport position, the shoulder blade in the shoulder grading position extending angularly downwardly below the edge of the grader blade and angularly forwardly from the front surface of the grader blade, the shoulder blade having an outer end and an inner end and a bottom edge, the inner end of the bottom edge of the shoulder blade being spaced from the front surface of the grader blade in the shoulder grading position whereby material engaged by the shoulder blade as the vehicle moves forwardly is forced by the shoulder blade to flow laterally inwardly toward the inner end of the shoulder blade and thereafter is forced by the grader blade to flow laterally outwardly between the inner end of the shoulder blade and the front surface of the grader blade toward said one end of the grader blade.

2. The apparatus of claim 1 in which the angle at which the bottom edge of the shoulder blade extends downwardly relative to the bottom edge of the grader blade is adjustable.

3. The apparatus of claim 1 including a hydraulic cylinder and piston attached to the grader blade and to the shoulder blade for pivoting the shoulder blade between the shoulder grading position and the transport position.

4. The apparatus of claim 1 in which the grader blade includes a top edge and the shoulder blade is pivotally attached to the grader adjacent the top edge thereof.

5. The apparatus of claim 1 including a restraining member attached to the shoulder blade and adapted to be attached to a vehicle whereby the downward angle between the shoulder blade and the bottom edge of the grader blade is limited by the restraining member.

6. The apparatus of claim 5 in which the restraining member is a chain.

7. The apparatus of claim 1 in which the shoulder blade includes a body and a cutting blade which is attached to the body and which forms the bottom edge of the shoulder blade.

8. The apparatus of claim 1 in which the grader blade in the shoulder grading position extends forwardly from the front surface of the grader blade at an angle of about 30° to about 90° relative to the bottom edge of the grader blade.

9. The apparatus of claim 8 in said angle is about 40° to about 80°.

10. The apparatus of claim 8 in which the bottom edge of the shoulder blade in the shoulder grading position extends downwardly relative to the bottom edge of the grader blade at an angle of about 10° to about 80°.

11. The apparatus of claim 1 in which the bottom edge of the shoulder blade in the shoulder grading position extends downwardly relative to the bottom edge of the grader blade at an angle of about 10° to about 80°.

12. The apparatus of claim 11 in which said angle is about 20° to about 60°.

13. The apparatus of claim 1 including a first lug on the grader blade and a second lug on the shoulder blade and a pin pivotally securing the first and second lugs together.

14. The apparatus of claim 1 in which the shoulder blade in the shoulder grading position extends laterally outwardly beyond said one end of the grader blade.

15. In combination, a vehicle having a body and wheels for supporting the vehicle on a road, the vehicle being adapted to be advanced over a road along a path, an underbody grader blade attached to the vehicle body and having front and rear surfaces, a pair of ends, and a bottom edge adapted to engage a road, a shoulder blade pivotally attached to the grader blade adjacent one end thereof and movable between a shoulder grading position and a transport position, the shoulder blade in the shoulder grading position extending:
a) angularly downwardly below the edge of the grader blade and below said wheels,
b) angularly forwardly from the front surface of the grader blade, and
c) at an acute angle to a line which is perpendicular to the path of advance of the vehicle,
the shoulder blade having an outer end and an inner end and a bottom edge, the inner end of the bottom edge of the shoulder blade being spaced from the front surface of the grader blade in the shoulder grading position whereby material engaged by the shoulder blade as the vehicle moves forwardly is forced by the shoulder blade to flow laterally inwardly toward the inner end of the shoulder blade and thereafter is forced by the grader blade to flow laterally outwardly between the inner end of the shoulder blade and the front surface of the grader blade toward said one end of the grader blade.

16. The combination of claim 15 in which the angle at which the bottom edge of the shoulder blade extends downwardly relative to the bottom edge of the grader blade and the wheels is adjustable.

17. The combination of claim 15 including a hydraulic cylinder and piston attached to the grader blade and to the shoulder blade for pivoting the shoulder blade between the shoulder grading position and the transport position.

18. The combination of claim 15 including a restraining member attached to the shoulder blade and to the vehicle whereby the downward angle between the shoulder blade and the bottom edge of the grader blade is limited by the restraining member.

19. The combination of claim 15 in which said acute angle between the shoulder blade and said perpendicular line is between about 10° and about 50°.

20. The combination of claim 19 in which said acute angle is between about 20° and about 40°.

21. The combination of claim 15 in which the bottom edge of the shoulder blade in the shoulder grading position extends downwardly relative to a plane defined by said wheels at an angle of about 10° to about 80°.

22. The combination of claim 21 in which said angle between the bottom edge of the shoulder blade and said plane is about 20° to about 60°.

23. The combination of claim 15 in which the shoulder blade in the shoulder grading position extends laterally outwardly beyond said one end of the grader blade.
